(19) United States
(12) Patent Application Publication
(10) Pub. No.: US 2024/0116374 A1
(43) Pub. Date: Apr. 11, 2024

(54) OPTIMIZING RESISTANCE OF BOAT USING MOVABLE BATTERY

(71) Applicant: Honda Motor Co., Ltd., Tokyo (JP)

(72) Inventor: Yutaka HAYASHI, Saitama (JP)

(73) Assignee: Honda Motor Co., Ltd., Tokyo (JP)

(21) Appl. No.: 17/960,145

(22) Filed: Oct. 5, 2022

(51) Int. Cl. B60L 50/60; B60L 58/10; B63B 79/10; B63B 79/40; H01M 10/42; H01M 10/48; H01M 50/244; H01M 50/249

(52) U.S. Cl. CPC B60L 50/66; B60L 58/10; B63B 79/10; B63B 79/40; H01M 10/425; H01M 10/48; H01M 50/244; H01M 50/249; H01M 2220/20

(57) ABSTRACT

A control system, adapted for a boat including a motor driving a propeller; a battery supplying electricity to the motor; an actuator moving the battery in a front-rear direction of a boat; a rail guiding a movement of the battery; a sensor detecting a travel speed of the boat, or detecting an electricity consumption amount of the battery. The control system includes a control unit, including a processor, configured to control the actuator to change a position of the battery based on the travel speed of the boat, or based on the electricity consumption amount of the battery.

### BACKGROUND OF THE DISCLOSURE

### Technical Field

The disclosure relates to a resistance of a boat, and more specifically relates to optimizing the resistance of the boat using a movable battery.

### Related Art

When a travel speed of the boat is low and the position of a center of gravity of the boat is rearward (i.e. a small longitudinal center of gravity LCG1), a rear side of the boat may sink deeper into water and resistance of the boat may become high such as shown in FIG. 1. Therefore, when the travel speed of a boat is low, it is desirable that the position of the center of gravity of the boat is not rearward, but forward (i.e. a large longitudinal center of gravity LCG2) as shown in FIG. 2, such that the rear side of the boat does not sink deeper into water and increase the resistance of the boat.

In addition, when the travel speed of the boat is high, it is desirable that the position of the center of gravity of the boat is rearward (i.e. a small longitudinal center of gravity LCG1) so that a gliding condition may be more easily achieved, where a front of the boat is raised up to glide on top of the water and resistance of the boat becomes less such as shown in FIG. 3. When the travel speed of the boat is high, the rear side of the boat does not sink deeper into water even when the center of gravity of the boat is rearward.

Therefore, a way for changing the center of gravity of the boat based on the travel speed of the boat is needed such that resistance acting on the boat may be optimized.

### SUMMARY

According to an embodiment of the disclosure, a control system adapted for a boat including a motor driving a propeller; a battery supplying electricity to the motor; an actuator moving the battery in a front-rear direction of a boat; a rail guiding a movement of the battery; a sensor detecting a travel speed of the boat, or detecting an electricity consumption amount of the battery is provided. The control system includes a control unit, including a processor, configured to control the actuator to change a position of the battery based on the travel speed of the boat, or based on the electricity consumption amount of the battery.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures.

FIG. 1 is a schematic diagram illustrating a configuration when a travel speed of the boat is low and a position of the center of gravity of the boat is rearward according to an embodiment of the disclosure.

FIG. 2 is a schematic diagram illustrating a configuration when the travel speed of a boat is low and a position of a center of gravity of the boat is forward according to an embodiment of the disclosure;

FIG. 3 is a schematic diagram illustrating a configuration when the travel speed of a boat is high and a position of a center of gravity of the boat is rearward according to an embodiment of the disclosure;

FIG. 4 is a schematic diagram illustrating a control system for optimizing resistance of a boat using a movable battery according to an embodiment of the disclosure;

FIG. 5 is a schematic diagram illustrating a top view of a boat having a movable battery moved to a first position according to an embodiment of the disclosure;

FIG. 6 is a schematic diagram illustrating a top view of a boat having a movable battery moved to a second position according to an embodiment of the disclosure;

FIG. 7 is a schematic diagram illustrating a side view of a boat having a movable battery moved to a first position according to an embodiment of the disclosure;

FIG. 8 is a schematic diagram illustrating a configuration where an actuator system is a motor according to an embodiment of the disclosure;

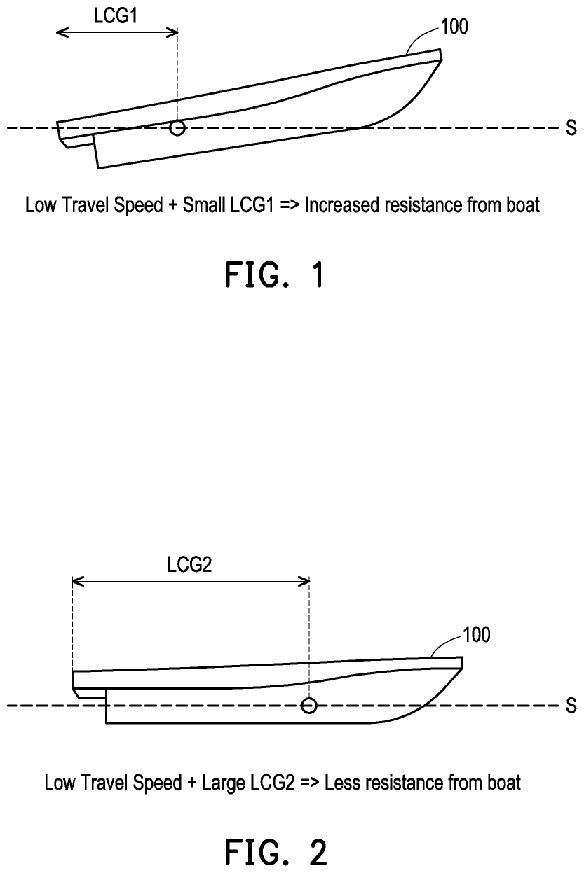

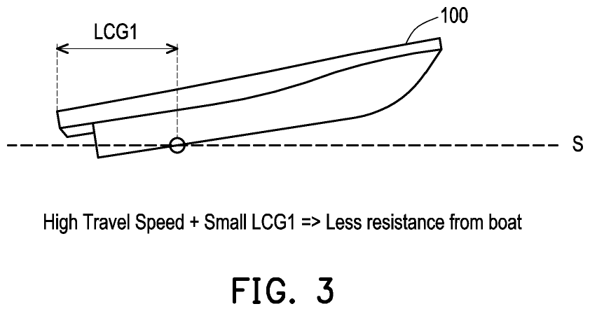

### DESCRIPTION OF THE EMBODIMENTS

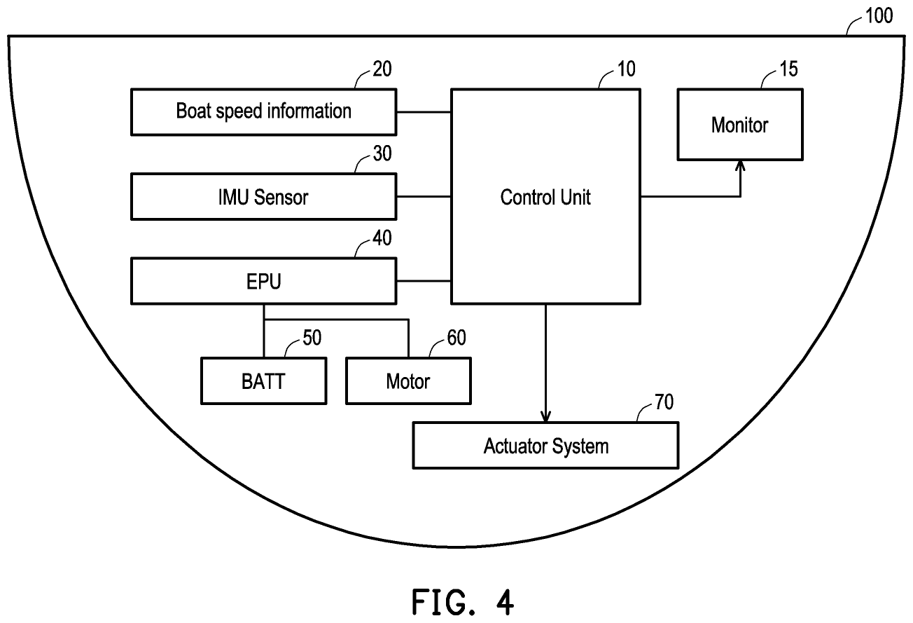

FIG. 4 is a schematic diagram illustrating a control system for optimizing resistance of a boat using a movable battery according to an embodiment of the disclosure. Referring to FIG. 4, a boat 100 is provided. The boat 100 may be, for example, a water vessel, a water craft, a ship and/or the like. The boat 100 may be, for example, a speed boat, a catamaran, a pontoon and/or the like.

The boat 100 includes a propulsion system, for example, a motor 60 for propelling the boat 100 in water. The motor 60 may be, for example, an inboard motor, an outboard motor, a partially inboard-partially outboard motor and the like. A propeller is coupled to an output shaft of the motor 60, wherein the motor 60 drives a rotation of the propeller. The motor 60 is attached to a stern side of the boat 100. The motor 60 is fixed to the stern side of the boat 100 such that an outer casing of the motor 60 is not movable relative to the boat 100.

The motor 60 is an electric motor. A battery 50 is coupled to the motor 60 by a power cable. The battery 50 supplies electricity to the motor 60. The boat 100 may include an electrical power unit EPU 40 for controlling a discharge of the battery 50.

The boat 100 includes a steering system, for example, a steering wheel coupled to a rudder to steer a direction of the boat 100. The steering wheel may be coupled to the rudder by, for example, a cable or a wire or the like.

Referring to FIG. 4, a control unit 10 is disposed on the boat 100. The control unit 10 includes, for example, a processor and a memory. In addition, a monitor 15 may be disposed on the boat 100. The monitor 15 is an example of a display unit. The monitor 15 is coupled to the control unit 10, wherein the control unit 10 may display an image on the monitor 15. An inertial measurement unit (IMU) 30 is coupled to the control unit 10. The IMU 30 may include, for example, a gyroscope. The control unit 10 may obtain an orientation or pointing direction of the boat 100 via the IMU 30.

Referring to FIG. 4, the control unit 10 receives a boat speed information 20 as an input. The boat speed information 20 includes information regarding a travel speed of the boat 100. A speed of the boat 100 may be measured by a sensor, for example, a speedometer, a global positioning system (GPS), and/or the like. The speedometer may include, for example, a pressure gauge and a pitot tube for estimating the speed of the boat 100. The GPS is an example of a Global Navigation Satellite System (GNSS). The control unit 10 may obtain the travel speed of the boat 100 via, for example, the sensor such as the speedometer and/or the GPS.

The control unit 10 may detect an electricity consumption amount of the battery 50, and/or the control unit 10 may detect an electricity consumption amount of the motor 60. Since the motor 60 is an electric motor consuming electricity from the battery 50, therefore the travel speed of the boat 100 may be estimated, predicted and/or determined from the electricity consumption amount of the battery 50 (or the electricity consumption amount of the motor 60). The electricity consumption amount of the battery 50 and the electricity consumption amount of the motor 60 are substantially the same. More specifically, the travel speed of the boat 100 may be estimated and/or determined from a rate of the electricity consumption amount of the battery 50. The electricity consumption amount of the battery 50 and/or the rate of the electricity consumption amount of the battery 50 may be obtained via, for example, the sensor such as the electrical power unit EPU 40. The electricity consumption amount of the battery 50 may include the rate of the electricity consumption amount of the battery 50. Units of the electricity consumption amount of the battery 50 may be, for example, in Watt-hours (Wh).

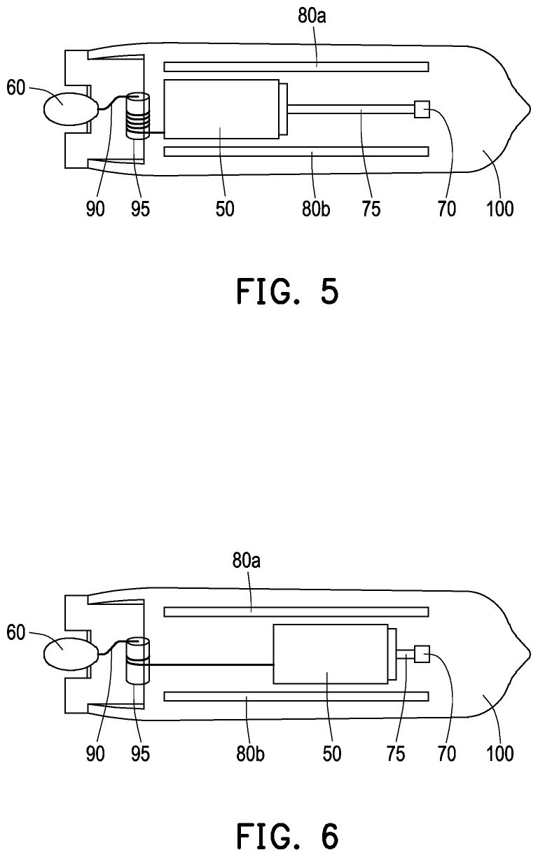

FIG. 5 is a schematic diagram illustrating a boat having a movable battery moved to a first position according to an embodiment of the disclosure. Referring to FIG. 5, the battery 50 is moved to a rear position of the boat 100. The rear position of the boat 100 is an example of the first position. The boat 100 includes a first rail 80a and a second rail 80b. The first rail 80a and the second rail 80b are examples of a rail of the disclosure. The rail guides a movement of the battery 50 in the front-rear direction of the boat 100. A number of the rails is not intended to limit the disclosure and may be set according to requirements.

Referring to FIG. 5, the boat 100 includes an actuator system 70 moving a position of the battery 50 in a front-rear direction of a boat 100. The actuator system 70 is a power source, and includes an actuator. More specifically, the actuator system 70 includes a power source that moves a position of the battery 50 in the front-rear direction of the boat 100. In the present embodiment, the actuator of the actuator system 70 is a hydraulic cylinder. However, the disclosure is not limited thereto. In another embodiment of the disclosure, the actuator may be, for example, an air cylinder, an electric motor and/or the like. The actuator moves the battery 50 in a front-rear direction of the boat 100. The front-rear direction of the boat 100 may be, for example, a bow-stern direction of the boat 100. The hydraulic cylinder (actuator system 70) includes a shaft 75 that extends and retracts, and may be controlled by the control unit 10. The battery 50 is fixed to an end of the shaft 75 to be extended and retracted with the shaft 75.

Referring to FIG. 5, the first rail 80a and the second rail 80b are fixed to the boat 100. More specifically, the first rail 80a and the second rail 80b may be fixed to the boat 100 by, for example, a bolt(s) and/or welding. The first rail 80a and the second rail 80b guide a movement of the battery 50 in the front-rear direction of the boat 100 when the actuator system 70 moves the battery 50. More specifically, the battery 50 may include, for example, a first linear block and a second linear block coupled or fixed to the battery 50, wherein the first linear block slides on the first rail 80a, and the second linear block slides on the second rail 80b, such that the first rail 80a and the second rail 80b guide the battery 50 when the battery 50 is moved by the hydraulic cylinder (the actuator system 70).

Referring to FIG. 5, the motor 60 and the battery 50 are electrically coupled by a cable 90. The cable 90 may be, for example, a retractable extension cable. Namely, the cable 90 may be stored on a roll type retractable storage device 95. The roll type retractable storage device 95 may include a cylinder rotating on a shaft, wherein a spring is coupled to the cylinder and the shaft so that the cable 90 may be extended and retracted. The roll type storage device 95 may include a bearing disposed between the cylinder and the shaft. The cable 90 is wound on the cylinder of the roll type retractable storage device 95.

In another embodiment of the disclosure, the roll type retractable storage device 95 may includes an electric motor (for example, a step motor, servo motor, and the like) instead of the spring. The electric motor may be coupled to the cylinder to rotate the cylinder such that the cable 90 may be extended and/or retracted via the rotation of the cylinder by the electric motor.

Referring to FIG. 4, the control unit 10 is coupled to the actuator system 70. The control unit 10 outputs (sends/transmits) control signals to the actuator system 70 to control the actuator system 70 to change a position of the battery 50 based on the travel speed of the boat 100. In addition, the control unit 10 may output control signals to the actuator system 70 to control the actuator system 70 to change a position of the battery 50 based on the electricity consumption amount of the battery 50 or the rate of the electricity consumption amount of the battery 50.

Referring to FIG. 5, the control unit 10 is configured to control the actuator system 70 to move a center of gravity of the boat 100 rearward to the first position when the travel speed of the boat 100 or the electricity consumption amount of the battery 50 (or motor 60) is greater than a predetermined threshold. That is to say, the battery 50 is moved to the rear position of the boat 100, such that the center of gravity of the boat 100 is moved rearward when the travel speed of the boat 100 is high (relative to the predetermined threshold), or when the electricity consumption amount of the battery 50 is high (relative to the predetermined threshold).

The predetermined threshold of the travel speed of the boat 100 for changing the position of the battery 50 may be, for example, 30 km/h, 35 km/h, 38 km/h, 46 km/h, 50 km/h, 55 km/h and the like. The predetermined threshold may be set according to requirements and is not intended to limit the disclosure. The predetermined threshold of the electricity consumption amount of the battery 50 may be set according to requirements and is not intended to limit the disclosure.

FIG. 6 is a schematic diagram illustrating a boat having a movable battery moved to a second position according to an embodiment of the disclosure. Referring to FIG. 6, the battery 50 is moved to a front position of the boat 100. The front position of the boat 100 is an example of the second position. In more detail, the control unit 10 is configured to control the actuator system 70 to move the center of gravity of the boat 100 forward when the travel speed of the boat 100 or the electricity consumption amount of the battery 50 is less than the predetermined threshold. That is to say, the battery 50 is moved to the front position of the boat 100, such that the center of gravity of the boat 100 is moved forward when the travel speed of the boat 100 is low (relative to the predetermined threshold), or when the electricity consumption amount of the battery 50 is low (relative to the predetermined threshold).

In the above embodiment, an example was described where the number of the positions of the battery was two positions. Namely, the actuator system 70 was configured to move the battery 50 between two positions only, namely the first position and the second position based on the travel speed of the boat 100 relative to the predetermined threshold. However, the disclosure is not limited thereto. That is to say, in another embodiment of the disclosure, the number of the positions of the battery may not be limited to two positions only.

In another embodiment of the disclosure, the position of the battery 50 may dynamically change according to the travel speed of the boat 100 or the electricity consumption amount of the battery 50. That is to say, a number of the positions of the battery is not limited to two positions only. In more detail, the number of positions (first position, second position, third position, fourth position, etc.) may be set according to requirements. In more detail, the actuator system 70 may move the battery 50 to a plurality of positions based on the travel speed of the boat 100 or the electricity consumption amount of the battery 50. That is to say, the position of the battery 50 in the boat 100 dynamically changes according to the travel speed of the boat 100 or the electricity consumption amount of the battery 50. The relationship between the plurality of positions of the battery 50 and the travel speed of the boat 100 may be predetermined, and may be set by a user according to requirements. The relationship between the plurality of positions of the battery 50 and the electricity consumption amount of the battery 50 may be predetermined, and may be set by a user according to requirements.

In an embodiment of the disclosure, the memory of the control unit 10 may store a length of the boat 100. The control unit 10 may be configured to control the position of the battery 50 based on the length of the boat 100 and at least one of the travel speed of the boat 100 or the electricity consumption amount of the battery 50. That is to say, the position of the center of gravity of the boat 100 may be computed based on the length of the boat 100.

In an embodiment of the disclosure, the memory of the control unit 10 may store a weight of the boat 100. The control unit 10 may be configured to control the position of the battery 50 based on the weight of the boat 100 and at least one of the travel speed of the boat 100 or the electricity consumption amount of the battery 50. That is to say, the position of the center of gravity of the boat 100 may be computed based on the weight of the boat 100.

In an embodiment of the disclosure, the memory of the control unit 10 may store the length of the boat 100 and the weight of the boat 100. The control unit 10 may be configured to control the position of the battery 50 based on the length of the boat 100, the weight of the boat 100, and at least one of the travel speed of the boat 100 or the electricity consumption amount of the battery 50. That is to say, the position of the center of gravity of the boat 100 may be computed based on the length of the boat 100 and the weight of the boat 100.

In an embodiment of the disclosure, the memory of the control unit 10 may store a position of the center of gravity of the boat 100 and the weight of the battery 50. The control unit 10 may be configured to control the position of the battery 50 based on the position of the center of gravity of the boat 100, the weight of the battery 50, and at least one of the travel speed of the boat 100 or the electricity consumption amount of the battery 50. By knowing the position of the center of gravity of the boat 100 and the weight of the battery 50, the control unit 10 may calculate and determine the position of the battery 50 for optimizing resistance of the boat 100 based on the travel speed of the boat 100 or the electricity consumption amount of the battery 50.

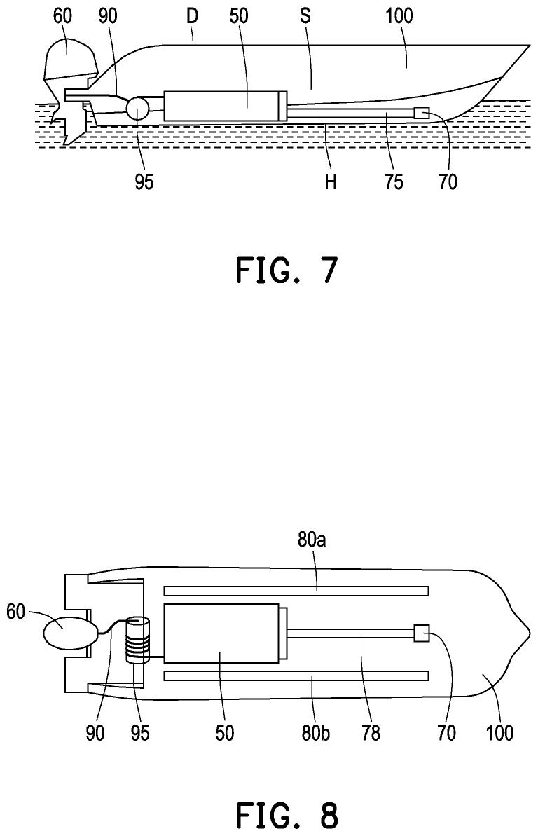

FIG. 7 is a schematic diagram illustrating a side view of a boat having a movable battery moved to a first position according to an embodiment of the disclosure. Referring to FIG. 7, the boat 100 includes a deck D and a hull H. In more detail, the deck D may be an upper deck of the boat 100. The deck D is a platform that covers the hull H. The boat 100 includes a space S disposed between the hull H and the deck D of the boat 100. The space S is disposed to extend along the front-rear direction of the boat 100. The rail 80a, 80b is disposed in the space S formed between the hull H and the deck D. More specifically, the rail 80a, 80b are disposed in a part of the space S formed between the hull H and the deck D. The actuator system 70, the battery 50, the, cable 90, the roll type storage device 95 may be disposed in the space S.

In another embodiment of the disclosure, the rail 80a, 80b, the actuator system 70, the battery 50, the, cable 90, the roll type storage device 95 may not be disposed in the space S, but disposed on the deck D. In another embodiment of the disclosure, the rail 80a, 80b, the actuator system 70, the battery 50, the, cable 90, the roll type storage device 95 may be disposed in both the space S and on the deck D.

FIG. 8 is a schematic diagram illustrating a configuration where an actuator system is a motor according to an embodiment of the disclosure. Referring to FIG. 8, the actuator system 70 is a motor, instead of the hydraulic cylinder. More specifically, the actuator system 70 is an electric motor, for example, a step motor, a servo motor, a DC motor, an AC motor and the like. The actuator system 70 includes a screw 78, wherein the screw 78 is coupled to an output shaft of the motor 70, and the screw 78 is rotated by rotating the motor 70. For example, when the screw 78 is rotated clockwise, the battery 50 is moved toward the motor (the actuator system 70), and when the screw 78 is rotated counter clockwise, the battery 50 is moved away from the motor (the actuator system 70). The screw 78 may be, for example, a lead screw or a ball screw and the like.

In the above embodiments, the motor 60 is fixed to the stern side of the boat 100 such that the motor 60 is not movable relative to the boat 100, but the battery 50 is movable relative to the boat 100. However, the disclosure is not limited thereto. In another embodiment of the disclosure, the motor 60 and the battery 50 may both be movable in the front-rear direction of the boat 100. For example, both the motor 60 and the battery 50 may both be movable using the actuator system 70.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control system, adapted for a boat including a motor driving a propeller; a battery supplying electricity to the motor; an actuator moving the battery in a front-rear direction of a boat; a rail guiding a movement of the battery; a sensor detecting a travel speed of the boat, or detecting an electricity consumption amount of the battery, the control system comprising:
a control unit, comprising a processor, configured to:
control the actuator to change a position of the battery based on at least one of the travel speed of the boat, or the electricity consumption amount of the battery.

2. The control system according to claim 1, wherein the control unit is configured to control the actuator to move a center of gravity of the boat rearward when the travel speed of the boat or the electricity consumption amount of the battery is greater than a predetermined threshold.

3. The control system according to claim 1, wherein the control unit is configured to control the actuator to move a center of gravity of the boat forward when the travel speed of the boat or the electricity consumption amount of the battery is less than a predetermined threshold.

4. The control system according to claim 1, further comprising:
a memory;
wherein the memory stores a length of the boat, and the control unit is configured to control the position of the battery based on the length of the boat and at least one of the travel speed of the boat or the electricity consumption amount of the battery.

5. The control system according to claim 1, further comprising:
a memory;
wherein the memory stores a weight of the boat, and the control unit is configured to control the position of the battery based on the weight of the boat and at least one of the travel speed of the boat or the electricity consumption amount of the battery.

6. The control system according to claim 1, wherein the travel speed of the boat is obtained by a GPS.

7. A boat, comprising:
a motor driving a propeller;
a battery, supplying electricity to the motor;
an actuator moving the battery in a front-rear direction of a boat;
a rail guiding a movement of the battery;
a sensor detecting a travel speed of the boat, or detecting an electricity consumption amount of the battery;
a control unit, comprising a processor, configured to:
control the actuator to change a position of the battery based on at least one of the travel speed of the boat, or the electricity consumption amount of the battery.

8. The boat according to claim 7, wherein the boat includes a space disposed between a hull and a deck of the boat, the space is disposed along the front-rear direction of the boat, and the rail is disposed in a part of the space.

9. The boat according to claim 8, wherein the boat is a catamaran.

10. The boat according to claim 8, wherein the boat is a pontoon.

11. The boat according to claim 7, wherein the control unit is configured to control the actuator to move a center of gravity of the boat rearward when the travel speed of the boat or the electricity consumption amount of the battery is greater than a predetermined threshold.

12. The boat according to claim 7, wherein the control unit is configured to control the actuator to move a center of gravity of the boat forward when the travel speed of the boat or the electricity consumption amount of the battery is less than a predetermined threshold.

13. The boat according to claim 7, further comprising:
a memory;
wherein the memory stores a length of the boat, and the control unit is configured to control the position of the battery based on the length of the boat and at least one of the travel speed of the boat or the electricity consumption amount of the battery.

14. The boat according to claim 7, further comprising:
a memory;
wherein the memory stores a weight of the boat, and the control unit is configured to control the position of the battery based on the weight of the boat and at least one of the travel speed of the boat or the electricity consumption amount of the battery.

15. The boat according to claim 7, further comprising:
a GPS;
wherein the travel speed of the boat is obtained by the GPS.

16. The boat according to claim 7, wherein the motor and the battery are coupled by a cable, and the cable is a retractable extension cable.
